(19) United States
(12) Patent Application Publication
(10) Pub. No.: US 2026/0177424 A1
(43) Pub. Date: Jun. 25, 2026

(54) WAVELENGTH DETECTION SYSTEM

(71) Applicant: NERO ENDÜSTRI SAVUNMA SANAYI ANONIM SIRKETI, Ankara (TR)

(72) Inventors: ONUR ERDOGAN, Ankara (TR); SULE ÖZDILEK, Ankara (TR); ALICAN ÖKÇÜN, Ankara (TR)

(73) Assignee: NERO ENDÜSTRI SAVUNMA SANAYI ANONIM SIRKETI, Ankara (TR)

(21) Appl. No.: 18/833,412

(22) PCT Filed: Jul. 24, 2023
(86) PCT No.: PCT/TR2023/050726

§ 371 Date: Jul. 26, 2024

(51) Int. Cl. G01J 1/42; G01J 1/02; G01J 1/44; G01J 9/00

(52) U.S. Cl. CPC G01J 1/4257; G01J 1/0228; G01J 1/0242; G01J 1/4228; G01J 2001/446; G01J 9/00

(57) ABSTRACT

The invention relates to a wavelength detection system that enables the detection of wavelength from light/laser sources using at least two different characteristic photodiodes.

### TECHNICAL FIELD

The invention relates to a wavelength detection system.

The invention specifically relates to a wavelength detection system that enables the detection of wavelength of light from light sources, such as light or laser sources, using at least two different characteristic photodiodes.

### BACKGROUND

A photodiode is a semiconductor device that converts light energy to electrical energy. Light energy stimulates electrons in the semiconductor structure within the photodiode. This situation cause electron flow and generate an electrical current in photodiode. Photodiodes are used in electrical circuits for light detection, measuring light levels, remote control systems, and energy generation in solar panels, among various other applications.

The wavelength detection of light/laser emitted from light sources have become crucial during the recent years. In current systems, optical filters are used to filter the incoming light to photodiodes for detection the wavelength of the light. In this way, the desired to detect wavelength is directed onto the photodiode from the various wavelengths of light on photodiode's surface . . . The wavelength of the used filter is assumed to be equal to the filtered wavelength of the light detected by the photodiode. However, the use of optical filters in current systems leads to many errors and loss of sensitivity.

In the current system, without the use of an additional component/product, photodiodes cannot detect light/laser sources at specific wavelengths that desired to detect. Optical filters are used in current systems. The wavelength of the light/laser source filtered by the optical filter can be detected with a certain margin of error. However, the measurement accuracy is significantly reduced due to the optical filters affecting the intensity of the light/laser source. Due to optical filters reduced the intensity of light photodiodes have shorter detection range. Additionally, the use of optical filters significantly reduces the detection angle of the photodiodes.

In the current system, there is no mechanism to prevent false signals that can occur in various forms (e.g., sun glare). The lack of prevention of false signals leads to incorrect information being transferred to the control mechanism in sensitive devices where photodiodes are used.

Based on the research conducted, application number TR2018/00545 has been found. The application discusses an illumination arrangement suitable for underwater lighting. However, the application does not mention a system that measures the wavelength, power, and angle of incidence of light/laser emitted from the light source.

As a result, due to the aforementioned drawbacks and the inadequacy of current solutions in the field, it has become necessary to make advancements in the relevant technical area.

### Aim of the Invention

The invention is created inspired by the existing circumstances and aims to address the mentioned drawbacks.

The main aim of the invention is to measure the wavelength, power and angle of incidence of light/laser emitted from the light source.

Another aim of the invention is to enable photodiodes to perform analog detection instead of digital detection.

Another aim of the invention is to eliminate the necessity of using filters for photodiodes to detect the desired wavelength.

Another aim of the invention is to enable the detection of the wavelength of the incoming laser or light independently of power and distance.

A wavelength detection system, which enables the measurement of wavelength, power, and angle of light/laser emitted from a light or laser source, characterized by comprising; at least two photodiodes with different characteristics to detect and convert the incoming light into electrical signals, a digitizer that receives the electrical signal from the photodiodes and converts it into a digital signal, a control unit that processes the digital signals based on the sensitivity differences between the photodiodes and utilizes software algorithms to determine the wavelength, power and angle of incidence of the light.

The structural and characteristic features of the present invention will be understood clearly by the following drawings and the detailed description made with reference to these drawings. Therefore, the evaluation shall be made by taking these figures and the detailed description into consideration.

### BRIEF DESCRIPTION OF THE DRAWING

FIG. 1 is a representative illustration of the wavelength detection system, which is the subject of the invention.

FIG. 2 is a representative illustration of the wavelength detection system, which is the subject of the invention.

FIG. 3 is a representative illustration of the wavelength detection system, which is the subject of the invention.

### REFERENCE NUMBERS

1. Photodiode
2. Digitiser
3. Control unit
VCC. Supply voltage
Q1. Transistor
R1, R2 Resistance
U. Amplifier

### DETAILED DESCRIPTION

In this detailed description, the preferred embodiments of the wavelength detection system, which is the subject of the invention, are explained solely for the purpose of better understanding the subject matter.

The wavelength detection system comprising of photodiodes, a Digitiser, and a control unit. The system enables photodiodes to perform analog detection instead of digital detection. Through the wavelength detection system, there is no longer a requirement for using filters for photodiodes to detect the desired wavelength. The wavelength detection system can be used in various fields where the wavelength of light/laser emitted from a source needs to be detected using photodiodes. One example field is laser warning systems. A system has been developed for the independent detection of the wavelength of incoming laser, regardless of its power and distance.

The wavelength detection system allows for the detection of the wavelength of any light/laser source by photodiodes without the need for optical filters. This is achieved by utilizing the sensitivity differences between photodiodes with different characteristics. The elimination of optical filter usage in the wavelength detection system significantly reduces the margin of error in wavelength detection. Additionally, the elimination of optical filters increases measurement accuracy. Furthermore, the removal of optical filter usage results in an increased detection range and detection angle.

Through the use of the system in the wavelength detection system, all false signals are filtered in the control unit. Photodiodes which have different characteristics give different sensivity graphs. The correlation of the graphs have one to one function. By utilizing this function, wavelength detection is performed, effectively preventing false signals.

The photodiode detects and converts the light/laser emitted from the source into an electrical signal. The digitizer converts the incoming electrical signal into a digital signal. The control unit processes the digital signal using the algorithm running within it.

The system utilizes photodiodes with different characteristics to generate different electrical signals in response to light/laser sources with the same wavelength. When these electrical signals are digitized and interpreted in a control unit, the wavelength, power, and angle of incidence of the light falling onto the photodiodes can be detected. In a system with two photodiodes, if the first photodiode generates signal A and the second photodiode generates signal B for the same light with wavelength X and power Y, the control unit can determine that the incoming light has a wavelength of X and power of Y. Therefore, through the wavelength detection system, the signals generated by light/laser sources with different characteristics (wavelengths) on the photodiodes can be interpreted using photodiodes with different characteristics, without the need for optical filters.

The working principle of the invention is as follows:
The incoming light signal is converted into an electrical signal using photodiodes with different characteristics. Each analog signal from the different photodiodes is digitized and converted into a digital signal. Each digital signal is processed by the control unit to determine the wavelength, power and angle of the light.

1. A wavelength detection system, which enables the measurement of wavelength, power and angle of light/laser emitted from a light or laser source, characterized by comprising;
at least two photodiodes with different characteristics to detect and convert the incoming light into electrical signals,
a digitizer that receives the electrical signal from the photodiodes and converts it into a digital signal,
a control unit that processes the digital signals based on the sensitivity differences between the photodiodes and utilizes software algorithms to determine the wavelength, power and angle of incidence of the light.
